(19) United States
(12) Patent Application Publication
(10) Pub. No.: US 2023/0274101 A1
(43) Pub. Date: Aug. 31, 2023

(54) USER TERMINAL, BROADCASTING APPARATUS, BROADCASTING SYSTEM COMPRISING SAME, AND CONTROL METHOD THEREOF

(71) Applicant: Kyung Cheol KIM, Cheongju-si (KR)

(72) Inventor: Kyung Cheol KIM, Cheongju-si (KR)

(21) Appl. No.: 17/784,022

(22) PCT Filed: Dec. 7, 2020
(86) PCT No.: PCT/KR2020/017734

§ 371 Date: Oct. 7, 2022

(30) Foreign Application Priority Data
Dec. 9, 2019 (KR) 10-2019-0162503

(51) Int. Cl. G06F 40/58; G10L 15/26; H04L 12/18; G10L 15/00; G06V 40/20

(52) U.S. Cl. CPC G06F 40/58; G10L 15/26; H04L 12/1831; G10L 15/005; G06V 40/28

(57) ABSTRACT

Disclosed are a broadcasting apparatus, a user terminal, a broadcasting system comprising same, and a control method thereof. The broadcasting apparatus, according to one aspect, may comprise: a communication unit that supports a video call between user terminals connected to a chat room through a communication network; an extraction unit that generates a video file and an audio file by using a video call-related video file received through the communication unit, and extracts original language information for each caller by using at least one of the video file and the audio file; a translation unit that generates translation information obtained by translating the original language information according to the language of a selected country; and a control unit that controls an interpretation/translation video, in which at least one of the original language information and the translation information is mapped to the video call-related video file, to be transmitted to viewer terminals and the user terminals connected to the chat room.

### TECHNICAL FIELD

The present invention relates to a user terminal, a broadcasting apparatus, a broadcasting system including the same, and a control method thereof, which provide a translation service when broadcasting video call contents in real-time.

### BACKGROUND ART

With the advancement in IT technology, video calls are frequently made between users, and in particular, people of various countries around the world use video call services for the purpose of sharing contents, hobbies, and the like, as well as business purposes.

However, it is practically difficult to make a video call with an interpreter in every video call from the aspect of cost and time, and researches on a method of providing real-time original text/translation services for video calls are under progress.

### DISCLOSURE OF INVENTION

### Technical Problem

Therefore, the present invention has been made in view of the above problems, and it is an object of the present invention to further facilitate exchange and understanding of opinions by providing an original text/translation service to viewers, as well as callers, in real-time, and further facilitate exchange and understanding of opinions among the hearing impaired, as well as the visually impaired, by providing an original text/translation service through at least one among a voice and text.

### Technical Solution

To accomplish the above object, according to one aspect of the present invention, there is provided a broadcasting apparatus comprising: a communication unit for supporting a video call between user terminals connected to a chat room through a communication network; an extraction unit for generating an image file and an audio file using a video call-related video file received through the communication unit, and extracting original language information for each caller using at least one among the image file and the audio file; a translation unit for generating translation information of the original language information translated according to a language of a selected country; and a control unit for controlling to transmit an interpreted/translated video, in which at least one among the original language information and the translation information is mapped to the video call-related video file, to viewer terminals and the user terminals connected to the chat room.

In addition, the original language information may include at least one among voice original language information and text original language information, and the translation information includes at least one among voice translation information and text translation information.

In addition, the extraction unit may extract voice original language information for each caller by applying a frequency band analysis process to the audio file, and generate text original language information by applying a voice recognition process to the extracted voice original language information.

In addition, the extraction unit may detect a sign language pattern by applying an image processing process to the image file, and generate text original language information based on the detected sign language pattern.

According to another aspect of the present invention, there is provided a user terminal comprising: a terminal communication unit for supporting a video call service through a communication network; and a terminal control unit for controlling to display, on a display, a user interface configured to provide an interpreted/translated video, in which at least one among original language information and translation information is mapped to a video call-related video file, and provide an icon for receiving at least one or more video call-related setting commands and at least one or more translation-related setting commands.

In addition, the at least one or more video call-related setting commands may include at least one among a speaking right setting command capable of setting a right to speak of a video caller, a command for setting the number of video callers, a command for setting the number of viewers, and a text transmission command.

In addition, the terminal control unit may control to display, on the display, a user interface configured to be able to change a method of providing the interpreted/translated video according to whether or not the speaking right setting command is input, or to provide a pop-up message including information on a caller having a right to speak.

According to another aspect of the present invention, there is provided a control method of a broadcasting apparatus, the method comprising the steps of: receiving a video call-related video file; extracting original language information for each caller using at least one among an image file and an audio file generated from the video call-related video file; generating translation information of the original language information translated according to a language of a selected country; and controlling to transmit an interpreted/translated video, in which at least one among the original language information and the translation information is mapped to the video call-related video file, to terminals connected to a chat room.

In addition, the extracting step may include the steps of: extracting voice original language information for each caller by applying a frequency band analysis process to the audio file; and generating text original language information by applying a voice recognition process to the extracted voice original language information.

In addition, the extracting step may include the step of detecting a sign language pattern by applying an image processing process to the image file, and generating text original language information based on the detected sign language pattern.

### Advantageous Effects

A user terminal, a broadcasting apparatus, a broadcasting system including the same, and a control method thereof according to an embodiment further facilitate exchange and understanding of opinions by providing an original text/translation service to viewers, as well as callers, in real-time.

A user terminal, a broadcasting apparatus, a broadcasting system including the same, and a control method thereof according to another embodiment further facilitate exchange and understanding of opinions among the hearing impaired, as well as the visually impaired, by providing an original text/translation service through at least one among a voice and text.

### BRIEF DESCRIPTION OF THE DRAWINGS

FIG. 1 is a view schematically showing the configuration of a video call broadcasting system according to an embodiment.

FIG. 2 is a block diagram schematically showing a control block of a video call broadcasting system according to an embodiment.

FIG. 3 is a view showing a user interface screen displayed on a display during a video call according to an embodiment.

FIG. 4 is a view showing a user interface screen configured to receive various setting commands according to an embodiment.

FIGS. 5 and 6 are views showing a user interface screen of which the configuration is changed according to a right to speak according to embodiments different from each other.

FIG. 7 is a flowchart schematically showing the operation flow of a broadcasting apparatus according to an embodiment.

### BEST MODE FOR CARRYING OUT THE INVENTION

The user terminal described below includes all devices that can provide a video call service through a communication network as a processor capable of performing various arithmetic operations and a communication module are embedded therein.

For example, the user terminal includes smart TVs (Television), IPTVs (Internet Protocol Television), and the like, as well as laptop computers, desktop computers, tablet PCs, mobile terminals such as smart phones and personal digital assistants (PDAs), and wearable terminals in the form of a watch or glasses that can be attached to a user's body, and there is no limitation. In the following descriptions, a person who uses a video call service using a user terminal will be interchangeably referred to as a user or a caller for convenience of explanation.

A viewer described below is a person who wants to watch a video call rather than to participate in the video call, and the viewer terminal described below includes all devices that can be used as the user terminal described above. Meanwhile, when it does not need to separately describe a user terminal and a viewer terminal, they will be commonly referred to as a terminal hereinafter.

In addition, the broadcasting apparatus described below may provide a video call service through a communication network as a communication module is embedded therein, and the broadcasting apparatus includes all devices embedded with a processor capable of performing various arithmetic operations.

For example, the broadcasting apparatus may be implemented through a smart TV (Television) or an IPTV (Internet Protocol Television), as well as a laptop computer, a desktop computer, a tablet PC, a mobile terminal such as a smart phone or a personal digital assistant (PDA), and a wearable terminal described above. In addition, the broadcasting apparatus may be implemented through a server embedded with a communication module and a processor, and there is no limitation. Hereinafter, the broadcasting apparatus will be described in more detail.

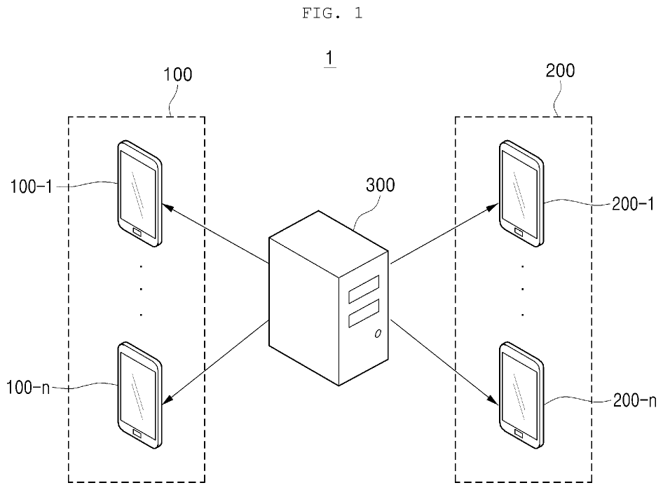

Hereinafter, although a user terminal and a viewer terminal in the form of a smart phone will be taken as an example and a broadcasting apparatus in the form of a server will be described as an example as shown in FIG. 1 for convenience of explanation, the forms of the user terminal, the viewer terminal, and the broadcasting apparatus are not limited thereto as described above, and there is no limitation.

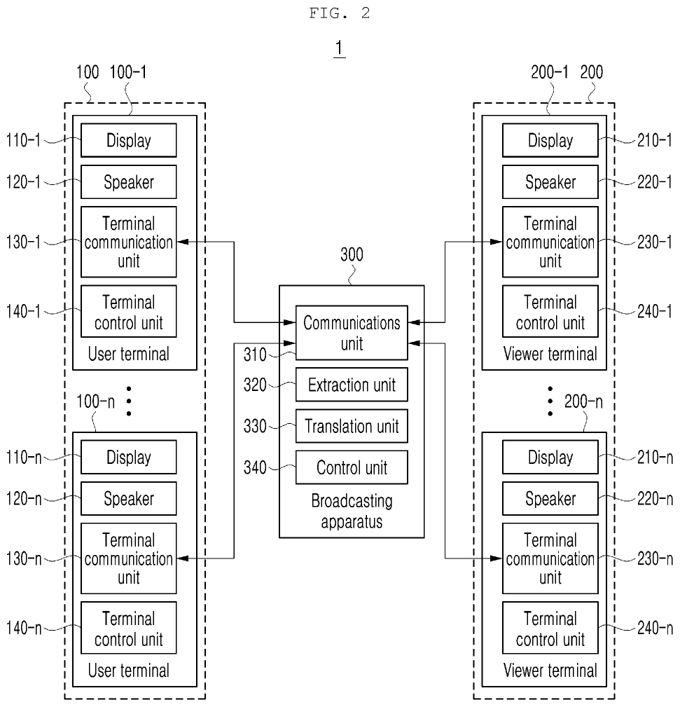

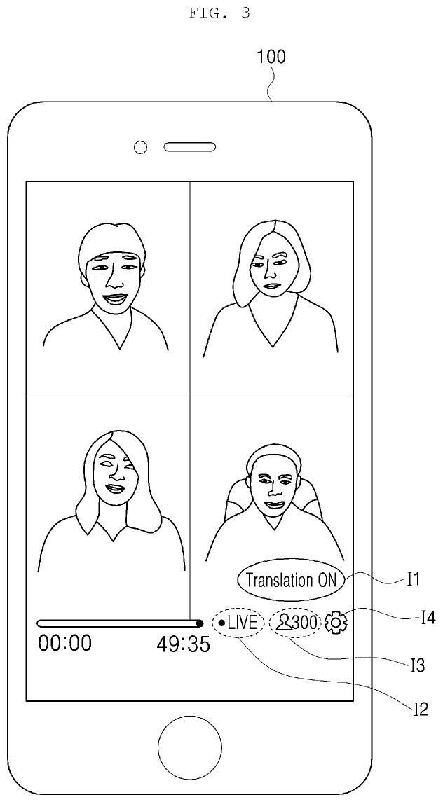

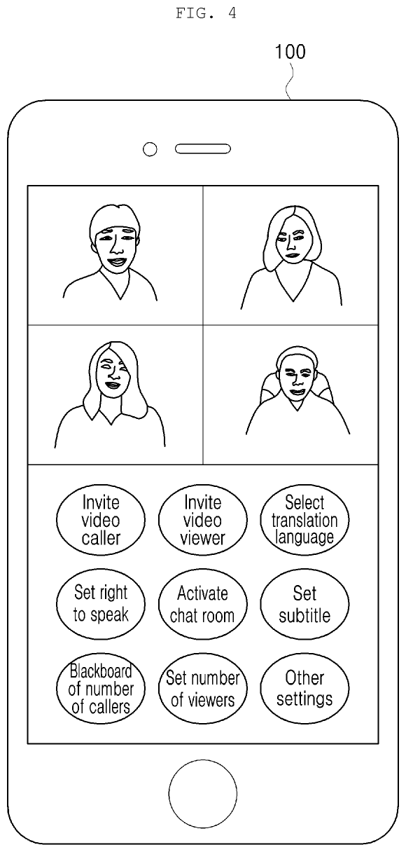

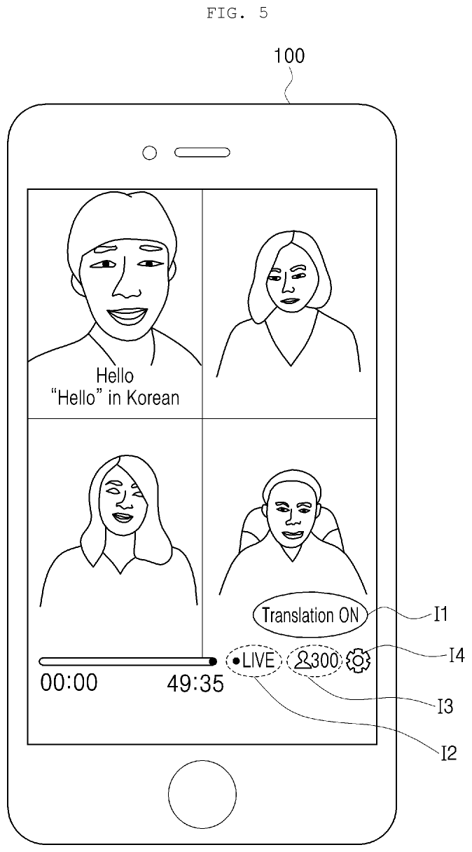

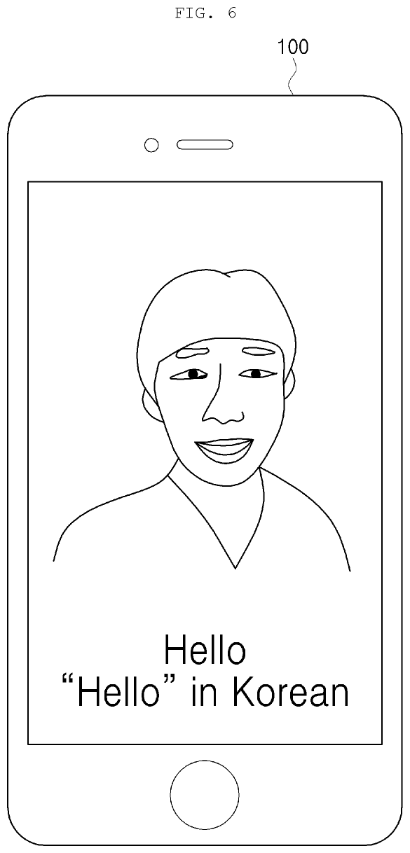

FIG. 1 is a view schematically showing the configuration of a video call broadcasting system according to an embodiment, and FIG. 2 is a block diagram schematically showing a control block of a video call broadcasting system according to an embodiment. FIG. 3 is a view showing a user interface screen displayed on a display during a video call according to an embodiment, and FIG. 4 is a view showing a user interface screen configured to receive various setting commands according to an embodiment. FIGS. 5 and 6 are views showing a user interface screen of which the configuration is changed according to a right to speak according to embodiments different from each other. Hereinafter, they will be described together to prevent duplication of description.

Referring to FIGS. 1 and 2, the broadcasting system 1 includes user terminals 100 (100-1, . . . , 100-n, n≥1), viewer terminals 200 (200-1, . . . , 200-n, m≥1), and a broadcasting apparatus 300 that supports connections between the user terminal 100 and the viewer terminal 200, and provides a translation service by transmitting a video call-related video file, together with original language information and translation information extracted from the video call-related video file. Hereinafter, the broadcasting apparatus 300 will be described in more detail.

Referring to FIG. 2, the broadcasting apparatus 300 may include a communication unit 310 for exchanging data with an external terminal through a communication network, and supporting a video call service between external terminals; an extraction unit 320 for generating an image file and an audio file using a video call-related video file received through the communications unit 310, and extracting original language information based thereon; a translation unit 330 for generating translation information by translating the original language information; and a control unit 340 for providing a broadcasting service and a translation service for a video call by controlling the overall operation of the components in the broadcasting apparatus 300.

Here, the communication unit 310, the extraction unit 320, the translation unit 330, and the control unit 340 may be implemented separately, or at least one of those may be implemented to be integrated in a system-on-chip (SOC). However, since there may be one or more system-on-chip in the broadcasting apparatus 300, it is not limited to integration in one system-on-chip, and there is no limitation in the implementation method. Hereinafter, the components of the broadcasting apparatus 300 will be described in detail.

The communication unit 310 may exchange various types of data with external devices through a wireless communication network or a wired communication network. Here, the wireless communication network means a communication network capable of wirelessly transmitting and receiving signals including data.

For example, the communication unit 310 may transmit and receive wireless signals between terminals through a base station in a 3-Generation (3G), 4-Generation (4G), or 5-Generation (5G) communication method, and in addition, it may exchange wireless signals including data with terminals within a predetermined distance through a communication method, such as wireless LAN, Wi-Fi, Bluetooth, Zigbee, Wi-Fi Direct (WFD), Ultra-wideband (UWB), Infrared Data Association (IrDA),

Bluetooth Low Energy (BLE), Near Field Communication (NFC), or the like.

In addition, the wired communication network means a communication network capable of transmitting and receiving signals including data by wire. For example, the wired communication network includes Peripheral Component Interconnect (PCI), PCI-express, Universal Serial Bus (USB), and the like, but it is not limited thereto. The communication network described below includes both a wireless communication network and a wired communication network.

The communication unit 310 may enable connections between the user terminals 100 through a communication network to provide a video call service, and may connect the viewer terminal 200 so that a viewer may watch a video call.

For example, when users gather and open a chat room to stream a video call in real-time, viewers may access the chat room. In this case, the communication unit 310 may allow a smooth video call between the users through a communication network, and also allow a real-time video call broadcasting service by transmitting video call contents to the viewers.

As a specific example, the control unit 340 may control the communication unit 310 to create a chat room in response to a chat room creation request received from the user terminal 100 through the communication unit 310, and then allows viewers to watch video calls through the viewer terminal 200 accessing the chat room. A detailed description of the control unit 340 will be described below.

Referring to FIG. 2, the broadcasting apparatus 300 may be provided with an extraction unit 320. The extraction unit 320 may generate an image file and an audio file using a video call-related video file received through the communication unit 310. The video call-related video file is a data collected from the user terminal 100 during a video call, and may include image information providing visual information and voice information providing auditory information. For example, the video call-related video file may mean a file storing caller's communication details using at least one among a camera and a microphone embedded in the user terminal 100.

In order to provide a translation service for all languages spoken during a video call, recognition of an original language is required first. Accordingly, the extraction unit 320 may separately generate an image file and an audio file from the video call-related video file, and then extract original language information from at least one among the image file and the audio file.

The original language information described below is information extracted from a communication means such as a voice, a sign language, or the like included in the video call-related video file, and the original language information may be extracted as a voice or text.

Hereinafter, for convenience of explanation, original language information configured of a voice will be referred to as voice original language information, and original language information configured of text will be referred to as text original language information. For example, when a character (caller) in a video call-related video speaks ‘Hello’ in English, the voice original language information is the voice ‘Hello’ spoken by the caller, and the text original language information means text ‘Hello’ itself. Hereinafter, a method of extracting the voice original language information from the audio file will be described.

Voices of various users may be contained in the audio file, and when these various voices are output at the same time, it may be difficult to identify the voices, and accuracy of translation may also be lowered. Accordingly, the extraction unit 320 may extract voice original language information for each user (caller) by applying a frequency band analysis process to the audio file.

The voice of each individual may be different according to gender, age group, pronunciation tone, pronunciation strength, or the like, and the voices may be individually identified by grasping corresponding characteristics when the frequency band is analyzed. Accordingly, the extraction unit 320 may extract voice original language information by analyzing the frequency band of the audio file and separating the voice of each caller appearing in the video call based on the analysis result.

The extraction unit 320 may generate text original language information, which is text converted from the voice, by applying a voice recognition process to the voice original language information. The extraction unit 320 may separately store the voice original language information and the text original language information for each caller.

The method of extracting voice original language information for each user through a frequency band analysis process and the method of generating text original language information from the voice original language information through a voice recognition process may be implemented as a data in the form of an algorithm or a program and previously stored in the broadcasting apparatus 300, and the extraction unit 320 may separately generate original language information using the previously stored data.

Meanwhile, a specific caller may use a sign language during a video call. In this case, unlike the method of extracting voice original language information from the audio file and then generating text original language information from the voice original language information, the extraction unit 320 may extract the text original language information directly from an image file. Hereinafter, a method of extracting text original language information from an image file will be described.

The extraction unit 320 may detect a sign language pattern by applying an image processing process to an image file, and generate text original language information based on the detected sign language pattern.

Whether or not to apply an image processing process may be set automatically or manually. For example, when a sign language translation request command is received from the user terminal 100 through the communication unit 310, the extraction unit 320 may detect a sign language pattern through the image processing process. As another example, the extraction unit 320 may determine whether a sign language pattern exists in the image file by automatically applying an image processing process to the image file, and there is no limitation.

The method of detecting a sign language pattern through an image processing process may be implemented as a data in the form of an algorithm or a program and previously stored in the broadcasting apparatus 300, and the extraction unit 320 may detect a sign language pattern included in the image file using the previously stored data, and generate text original language information from the detected sign language pattern.

The extraction unit 320 may store the original language information by mapping it with specific character information.

For example, as the extraction unit 320 identifies a user terminal 100 that has transmitted a specific voice, and then maps an ID preset to a corresponding user terminal 100, a nickname preset by the user (caller), or the like to the original language information, a viewer may accurately grasp which user makes which speech although a plurality of users simultaneously makes a voice.

As another example, when a plurality of callers is included in one video call-related video file, the extraction unit 320 may adaptively set character information according to a preset method or according to the characteristics of a caller detected from the video call-related video file. As an embodiment, the extraction unit 320 may identify the gender, age group, and the like of a character who makes a voice through a frequency band analysis process, and arbitrarily set and map a character's name determined to be the most suitable based on the result of the identification.

The control unit 340 may control the communication unit 310 to transmit original language information and translation information mapped with character information to the user terminal 100 and the viewer terminal 200, so that users and viewers may identify who the speaker is more easily. A detailed description of the control unit 340 will be described below.

Referring to FIG. 2, the broadcasting apparatus 300 may be provided with a translation unit 330. The translation unit 330 may generate translation information by translating the original language information in a language desired by a user or a viewer. In generating the translation information in a language input by a user or a viewer, the translation unit 330 may generate a translation result as text or a voice. As the broadcasting system 1 according to an embodiment provides each of the original language information and the translation information as a voice or text, there is an advantage in that the hearing impaired and the visually impaired may also use the video call service and watch the video.

Hereinafter, translation of the original language information in a language requested by a user or a viewer is referred to as translation information for convenience of explanation, and the translation information may also be configured in the form of a voice or text, like the original language information. At this point, translation information configured of text will be referred to as text translation information, and translation information configured of a voice will be referred to as voice translation information.

The voice translation information is voice information dubbed with a specific voice, and the translation unit 330 may generate voice translation information dubbed in a preset voice or a tone set by a user. The tone that each user desires to hear may be different. For example, a specific viewer may desire voice translation information of a male tone, and another viewer may desire voice translation information of a female tone. Accordingly, the translation unit 330 may generate the voice translation information in various tones so that viewers may watch more comfortably. Alternatively, the translation unit 330 may generate voice translation information in a voice tone similar to the speaker's voice based on a result of analyzing the speaker's voice, and there is no limitation.

As a translation method and a voice tone setting method used for translation, data in the form of an algorithm or a program may be previously stored in the broadcasting apparatus 300, and the translation unit 330 may perform translation using the previously stored data.

Referring to FIG. 2, the broadcasting apparatus 300 may be provided with a control unit 340 for controlling the overall operation of the components in the broadcasting apparatus 300.

The control unit 340 may be implemented as a processor, such as a micro control unit (MCU) capable of processing various arithmetic operations, and a memory for storing control programs or control data for controlling the operation of the broadcasting apparatus 300 or temporarily storing control command data or image data output by the processor.

At this point, the processor and the memory may be integrated in a system-on-chip (SOC) embedded in the broadcasting apparatus 300. However, since there may be one or more system-on-chips embedded in the broadcasting apparatus 300, it is not limited to integration in one system-on-chip.

The memory may include volatile memory (also referred to as temporary storage memory) such as SRAM and DRAM, and non-volatile memory such as flash memory, Read Only Memory (ROM), Erasable Programmable Read Only Memory (EPROM), Electrically Erasable Programmable Memory (EEPROM), and the like. However, it is not limited thereto, and may be implemented in any other forms known in the art.

In an embodiment, control programs and control data for controlling the operation of the broadcasting apparatus 300 may be stored in the non-volatile memory, and the control programs and control data may be retrieved from the non-volatile memory and temporarily stored in the volatile memory, or control command data or the like output by the processor may be temporarily stored in the volatile memory, and there is no limitation.

The control unit 340 may generate a control signal based on the data stored in the memory, and may control the overall operation of the components in the broadcasting apparatus 300 through the generated control signal.

For example, the control unit 340 may support a video call by controlling the communication unit 310 through a control signal. In addition, through the control signal, the control unit 340 may control the extraction unit 320 to generate an image file and an audio file from a video call-related file, for example, a video file, and extract original language information from at least one among the image file and the audio file.

The control unit 340 may control the communication unit 310 to facilitate communications between callers and viewers of various countries by transmitting an interpreted/translated video, which is generated by mapping at least one among original language information and translation information to a video call-related video file, to another user terminal on a video call and a viewer terminal 200 accessing a chat room, i.e., terminals accessing the chat room.

As described above, only the original language information or the translation information may be mapped in the interpreted/translated video, or the original language information and the translation information may be mapped together.

For example, when only text original language information and text translation information are mapped in the interpreted/translated video, the text original language information and the text translation information related to a corresponding speech may be included in the interpreted/translated video as a subtitle whenever a caller makes a speech. As another example, when voice translation information and text translation information are mapped in the interpreted/translated video, voice translation information dubbed in a language of a specific country may be included in the interpreted/translated video whenever a caller makes a speech, and the text translation information may be included a subtitle.

Meanwhile, the control unit 340 may change the method of providing a video call service and a translation service based on a setting command received from the user terminal 100 through the communication unit 310 or based on a previously set method.

For example, when a command for setting the number of video callers or a command for setting the number of viewers is received from the user terminal 100 through the communication unit 310, the control unit 340 may restrict access of the user terminal 100 and the viewer terminal 200 to the chat room according to a corresponding command.

As another example, when a separate text data or image data is received from the user terminal 100 or the viewer terminal 200 through the communication unit 310, the control unit 340 may transmit the received text data or image data together with original language/translation information so that opinions may be exchanged between the users and the viewers more reliably.

As another example, when a speaking right setting command, e.g., a command for limiting speech or a command for setting a speech order, is received from the user terminal 100 through the communication unit 310, the control unit 340 may transmit only an interpreted/translated video of a user terminal having a right to speak among a plurality of user terminals 100 in accordance with a corresponding command. Alternatively, the control unit 340 may transmit a pop-up message including information on a right to speak in accordance with a corresponding command, together with the interpreted/translated video, and there is no limitation in the implementation method.

In supporting a video call service and a translation service as described below and supporting the service as described above, applications that allow various settings may be stored in advance in the user terminal 100 and the viewer terminal 200 in accordance with preferences of individual users and viewers, and the users and viewers may perform various settings using a corresponding application. Hereinafter, the user terminal 100 will be described.

Referring to FIG. 2, the user terminal 100 may include a display 110 for visually providing various types of information to a user, a speaker 120 for aurally providing various types of information to a user, a terminal communication unit 130 for exchanging various types of data with external devices through a communication network, and a terminal control unit 140 for supporting a video call service by controlling the overall operation of the components in the user terminal 100.

Here, the terminal communication unit 130 and the terminal control unit 140 may be implemented separately or implemented to be integrated in a system-on-chip (SOC), and there is no limitation in the implementation method. Hereinafter, each component of the user terminal 100 will be described.

The user terminal 100 may be provided with a display 110 that visually provides various types of information to the user. According to an embodiment, the display 110 may be implemented as a liquid crystal display (LCD), a light emitting diode (LED), a plasma display panel (PDP), an organic light emitting diode (OLED), a cathode ray tube (CRT), and the like, but it is not limited thereto, and there is no limitation. Meanwhile, when the display 110 is implemented as a touch screen panel (TSP) type, a user may input various explanation commands by touching a specific region on the display 110.

The display 110 may display a video call-related video, and may receive various control commands through a user interface displayed on the display 110.

The user interface described below may be a graphical user interface, which graphically implements a screen displayed on the display 110, so that the operation of exchanging various types of information and commands between the user and the user terminal 100 may be performed more conveniently.

For example, the graphical user interface may be implemented to display icons, buttons and the like for easily receiving various control commands from the user in some regions on the screen displayed through the display 110, and display various types of information through at least one widget in some other regions, and there is no limitation.

For example, as shown in FIG. 3, it is configured to separately display videos of four different users on a video call in predetermined regions on the display 110, and a graphical user interface configured to include an icon Il for inputting a translation command, an emoticon 12 for providing information on the state of a video call service, an emoticon 13 informing the number of accessing viewers, and an icon 14 capable of inputting various setting commands may also be displayed on the display 110.

The terminal control unit 140 may control to display the graphical user interface as shown in FIG. 3 on the display 110 through a control signal. The display method, arrangement method and the like of widgets, icons, emoticons, and the like configuring the user interface may be implemented as a data in the form of an algorithm or a program and previously stored in the memory of the user terminal 100 or in the memory of the broadcasting apparatus 300, and the terminal control unit 140 may control to generate a control signal using the previously stored data and display the graphical user interface through the generated control signal. A detailed description of the terminal control unit 140 will be described below.

Meanwhile, referring to FIG. 2, the user terminal 100 may be provided with a speaker 120 capable of outputting various sounds. The speaker 120 is provided on one side of the user terminal 100 and may output various sounds included in the video call-related video file. The speaker 120 may be implemented through various types of known sound output devices, and there is no limitation.

The user terminal 100 may be provided with a terminal communication unit 130 for exchanging various types of data with external devices through a communication network.

The communication unit 130 may exchange various types of data with external devices through a wireless communication network or a wired communication network. Here, since the detailed description of the wireless communication network and the wired communication network are described above, they will be omitted.

The terminal communication unit 130 is connected to the broadcasting apparatus 300 through a communication network to open a chat room, and provides a video call service by exchanging a video call-related video file in real-time with other user terminals accessing the chat room, and in addition, may provide a broadcasting service by transmitting the video call-related video file to the viewer terminal 200 connected to the chat room.

Referring to FIG. 2, the user terminal 100 may be provided with a terminal control unit 140 for controlling the overall operation of the user terminal 100.

The terminal control unit 140 may be implemented as a processor, such as an MCU capable of processing various arithmetic operations, and a memory for temporarily storing control programs or control data for controlling the operation of the user terminal 100 or control command data or image data output by the processor.

At this point, the processor and the memory may be integrated in a system-on-chip embedded in the user terminal 100. However, since there may be one or more system-on-chips embedded in the user terminal 100, it is not limited to integration in one system-on-chip.

The memory may include volatile memory (also referred to as temporary storage memory) such as SRAM and DRAM, and non-volatile memory such as flash memory, Read Only Memory (ROM), Erasable Programmable Read Only Memory (EPROM), Electrically Erasable Programmable Memory (EEPROM), and the like. However, it is not limited thereto, and may be implemented in any other forms known in the art.

In an embodiment, control programs and control data for controlling the operation of the user terminal 100 may be stored in the non-volatile memory, and the control programs and control data may be retrieved from the non-volatile memory and temporarily stored in the volatile memory, or control command data or the like output by the processor may be temporarily stored in the volatile memory, and there is no limitation.

The terminal control unit 140 may generate a control signal based on the data stored in the memory, and may control the overall operation of the components in the user terminal 100 through the generated control signal.

For example, the terminal control unit 140 may control to display various types of information on the display 110 through a control signal. When a video file, in which at least one among original language information and translation information is mapped to an image file, is received from four users through the terminal communication unit 130, respectively, the terminal control unit 140 may control to display a video file for each user by partitioning the screen into four on the display as shown in FIG. 3.

In addition, the terminal control unit 140 may control to display a user interface for inputting various setting commands of a video call service on the display 110, and may change the configuration of the user interface based on the setting commands input through the user interface.

For example, when a user clicks the icon 14 shown in FIG. 3, the terminal control unit 140 may control to reduce the region where a video call-related video is displayed on the display 120 as shown in FIG. 4, and display a user interface configured to display an icon for receiving various setting commands from the user. Specifically, referring to FIG. 4, the terminal control unit 140 may control to display, on the display 110, a user interface which includes an icon for receiving a video caller invitation command, a viewer invitation command, a translation language selection command, a speaking right setting command, a chat room activation command, a subtitle setting command, a command for setting the number of callers, a command for setting the number of viewers, and other settings, and the setting commands that can be input are not limited to the examples described above.

As an embodiment, when a user invites another user by clicking a video caller invitation icon, the terminal control unit 140 may additionally partition the region in which the video call-related video is displayed in accordance with the number of invited users.

As another embodiment, when a user clicks a speaking right setting icon, the terminal control unit 140 may display the video of a user having a right to speak to be highlighted through various methods.

For example, as shown in FIG. 5, the terminal control unit 140 may control to display a user interface implemented to set an interpreted/translated video of a user having a right to speak to be larger than the videos for other users on the display 110. As another example, as shown in FIG. 6, the terminal control unit 140 may control to display only the interpreted/translated video of a user having a right to speak on the display 110.

In addition, the terminal control unit 140 may control to differently display a video of a user having a right to speak and a video of a user who does not have a right to speak through various methods, and there is no limitation.

A method of configuring the user interface described above may be implemented as a data in the form of a program or an algorithm and previously stored in the user terminal 100 or the broadcasting apparatus 300. When the method is previously stored in the broadcasting apparatus 300, the terminal control unit 140 may control to receive the data from the broadcasting apparatus 300 through the terminal communication unit 130, and then display the user interface on the display 110 based on the data.

Since the configuration of the viewer terminal 200 is the same as that of the user terminal 100, a detailed description thereof will be omitted. Meanwhile, the user interface displayed on the display of the viewer terminal 200 may be the same as or different from that of the user terminal 100. For example, since a viewer of the viewer terminal 200 is unable to participate in a video call, an icon capable of inputting the video caller invitation command may be excluded from the user interface.

In addition, the user interface implemented on the viewer terminal 200 may be configured to be different from the user interface implemented on the user terminal 100 considering convenience of the user or the viewer, and there is no limitation. Hereinafter, the operation of the broadcasting apparatus will be described briefly.

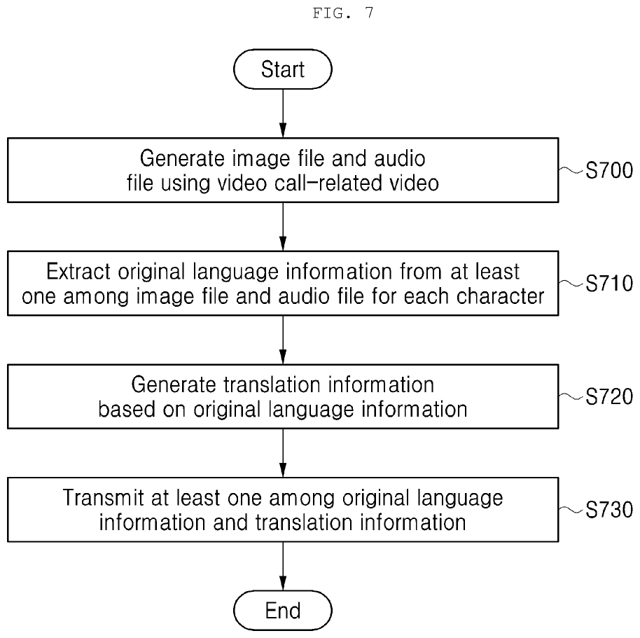

FIG. 7 is a flowchart schematically showing the operation flow of a broadcasting apparatus according to an embodiment.

The broadcasting apparatus may provide a video call service by connecting the user terminal and the viewer terminal. Therefore, the broadcasting apparatus may collect video call data from the user terminal on a video call while providing the video call service. The video call data is a data generated using at least one among a camera and a microphone embedded in the user terminal, and may mean a data in which user's communication details is stored using at least one among the camera and the microphone described above.

The broadcasting apparatus may separately generate an image file and an audio file from a video call-related video (700), and extract original language information for each user using at least one among the generated image file and audio file (710).

Here, the original language information is information expressing the communication means included in the video call-related video in the form of at least one among a voice and text, and it corresponds to the information before being translated in a language of a specific country.

The broadcasting apparatus may extract the original language information by using both or only one among the image file and the audio file according to a communication means used by the callers appearing in the video call-related video.

For example, when any one of the callers appearing in the video call-related video makes a video call using a voice while another caller is making a video call using a sign language, the broadcasting apparatus may extract the original language information by identifying a sign language pattern from the image file and a voice from the audio file.

As another example, when callers are making a video call using only a voice, the broadcasting apparatus may extract the original language information using only the audio file, and as another example, when callers are having a conversation using only a sign language, the broadcasting apparatus may extract the original language information using only the image file.

The broadcasting apparatus may individually generate translation information from the original language information in response to a request of the caller or the viewer (720), and transmit an interpreted/translated video, in which at least one among the original language information and the translation information is mapped, to all terminals, i.e., the user terminals and the viewer terminals, accessing the chat room.

The broadcasting apparatus may generate translation information by translating the original language information by itself, or may transmit the original language information to an external server that performs the translation process, and receive and provide the translation information in order to prevent the computing overload, and there is no limitation in the implementation form.

The broadcasting apparatus may transmit at least one among the original language information and the translation information (730). At this point, as the broadcasting apparatus transmits an interpreted/translated video, in which at least one among the original language information and the translation information is mapped to a video call-related video, communications between callers may be facilitated, and viewers may also accurately grasp opinions of the callers.

In addition, as the user interface according to an embodiment supports a text transmission function as described above so that the callers or viewers may transmit their opinions as text, communications may be further facilitated, and in addition, as the user interface supports a function of setting a right to speak, exchange of opinions may be further facilitated.

The configurations shown in the embodiments and drawings described in the specification are only preferred examples of the disclosed invention, and there may be various modified examples that may replace the embodiments and drawings of this specification at the time of filing of the present application.

In addition, the terms used in this specification are used to describe the embodiments, and are not intended to limit and/or restrict the disclosed invention. Singular expressions include plural expressions unless the context clearly dictates otherwise. In this specification, terms such as “comprises” or “have” are intended to specify presence of the features, numbers, steps, operations, components, parts, or combinations thereof described in this specification, and do not preclude the possibility of presence or addition of one or more other features, numbers, steps, operations, components, parts, or combinations thereof.

In addition, although the terms including ordinal numbers, such as “first”, “second”, and the like, used in this specification may be used to describe various components, the components are not limited by the terms, and the terms are used only for the purpose of distinguishing one component from other components. For example, a first component may be referred to as a second component without departing from the scope of the present invention, and similarly, a second component may also be referred to as a first component. The term “and/or” includes a combination of a plurality of related listed items or any one item of the plurality of related listed items.

In addition, the terms such as “˜unit”, “˜group”, “˜block”, “˜member”, “˜module”, and the like used throughout this specification may mean a unit that processes at least one function or operation. For example, the terms may mean software or hardware such as FPGA or ASIC. However, “˜unit”, “˜group”, “˜block”, “˜member”, “˜module”, and the like are not a meaning limited to software or hardware, and “˜unit”, “˜group”, “˜block”, “˜member”, “˜module”, and the like may be configurations stored in an accessible storage medium and executed by one or more processors.

### DESCRIPTION OF SYMBOLS

1: Broadcasting system
100: User terminal
200: Viewer terminal
300: Broadcasting apparatus

1. A broadcasting apparatus comprising:
a communication unit for supporting a video call between user terminals connected to a chat room through a communication network;
an extraction unit for generating an image file and an audio file using a video call-related video file received through the communication unit, and extracting original language information for each caller using at least one among the image file and the audio file;
a translation unit for generating translation information of the original language information translated according to a language of a selected country; and
a control unit for controlling to transmit an interpreted/translated video, in which at least one among the original language information and the translation information is mapped to the video call-related video file, to viewer terminals and the user terminals connected to the chat room.

2. The apparatus according to claim 1, wherein the original language information includes at least one among voice original language information and text original language information, and the translation information includes at least one among voice translation information and text translation information.

3. The apparatus according to claim 1, wherein the extraction unit extracts voice original language information for each caller by applying a frequency band analysis process to the audio file, and generates text original language information by applying a voice recognition process to the extracted voice original language information.

4. The apparatus according to claim 1, wherein the extraction unit detects a sign language pattern by applying an image processing process to the image file, and generates text original language information based on the detected sign language pattern.

5. A user terminal comprising:
a terminal communication unit for supporting a video call service through a communication network; and
a terminal control unit for controlling to display, on a display, a user interface configured to provide an interpreted/translated video, in which at least one among original language information and translation information is mapped to a video call-related video file, and provide an icon for receiving at least one or more video call-related setting commands and at least one or more translation-related setting commands.

6. The apparatus according to claim 5, wherein the at least one or more video call-related setting commands include at least one among a speaking right setting command capable of setting a right to speak of a video caller, a command for setting the number of video callers, a command for setting the number of viewers, and a text transmission command.

7. The apparatus according to claim 6, wherein the terminal control unit controls to display, on the display, a user interface configured to be able to change a method of providing the interpreted/translated video according to whether or not the speaking right setting command is input, or to provide a pop-up message including information on a caller having a right to speak.

8. A control method of a broadcasting apparatus, the method comprising the steps of:
receiving a video call-related video file;
extracting original language information for each caller using at least one among an image file and an audio file generated from the video call-related video file;
generating translation information of the original language information translated according to a language of a selected country; and
controlling to transmit an interpreted/translated video, in which at least one among the original language information and the translation information is mapped to the video call-related video file, to terminals connected to a chat room.

9. The method according to claim 8, wherein the extracting step includes the steps of:
extracting voice original language information for each caller by applying a frequency band analysis process to the audio file; and
generating text original language information by applying a voice recognition process to the extracted voice original language information.

10. The method according to claim 8, wherein the extracting step includes the step of detecting a sign language pattern by applying an image processing process to the image file, and generating text original language information based on the detected sign language pattern.
